(19) United States
(12) Patent Application Publication
(10) Pub. No.: US 2012/0055977 A1
(43) Pub. Date: Mar. 8, 2012

(54) SYSTEM FOR USING HIGH ROTARY SPEED FOR MINIMIZING THE LOAD DURING FRICTION STIR WELDING

(76) Inventors: Russell J. Steel, Salem, UT (US); Scott M. Packer, Alpine, UT (US); David Rosal, West Bountiful, UT (US); Michael P. Miles, Springville, UT (US)

(21) Appl. No.: 13/196,737

(22) Filed: Aug. 2, 2011

Related U.S. Application Data
(60) Provisional application No. 61/369,934, filed on Aug. 2, 2010.

(51) Int. Cl. B23K 20/12; B23K 11/00; H05B 6/02

(52) U.S. Cl. 228/112.1; 228/2.1; 219/600; 219/117.1

(57) ABSTRACT

A system and method for using Friction Stir Spot Joining (FSSJ) to join workpieces made of Advanced High Strength Steels (AHSS), wherein a first embodiment is a FSSJ tool that has no surface features, and wherein the rate of rotation of the FSSJ tool is much higher than is used in other FSW techniques to thereby reduce torque by causing plasticization of the AHSS on a small scale, and in a second embodiment, conventional FSSJ tools can be used at conventional FSSJ speeds if the FSSJ tool is manufactured from conductive tool materials having a high hardness, and heating of the FSSJ tool and/or the workpieces enhances the ability of the FSSJ tool to functionally weld the AHSS.

### CROSS REFERENCE TO RELATED APPLICATIONS

This document claims priority to and incorporates by reference all of the subject matter included in the provisional patent application docket number 4832.SMII.PR, having Ser. No. 61/69,934.

### BACKGROUND OF THE INVENTION

1. Field of the Invention

This invention relates generally to friction stir welding (FSW) and its variations including friction stir processing (FSP), friction stir spot welding (FSSW), friction stir spot joining (FSSJ) and friction stir mixing (FSM) (and hereinafter referred to collectively as “friction stir welding”).

2. Description of Related Art

Friction stir welding is a technology that has been developed for welding metals and metal alloys. Friction stir welding is generally a solid state process. Solid state processing is defined herein as a temporary transformation into a plasticized state that typically does not include a liquid phase. However, it is noted that some embodiments allow one or more elements to pass through a liquid phase, and still obtain the benefits of the present invention.

The friction stir welding process often involves engaging the material of two adjoining workpieces on either side of a joint by a rotating stir pin. Force is exerted to urge the pin and the workpieces together and frictional heating caused by the interaction between the pin, shoulder and the workpieces results in plasticization of the material on either side of the joint. The pin and shoulder combination or “FSW tip” is traversed along the joint, plasticizing material as it advances, and the plasticized material left in the wake of the advancing FSW tip cools to form a weld. The FSW tip can also be a tool without a pin so that the shoulder is processing another material through FSP.

FIG. 1 is a perspective view of a tool being used for friction stir welding that is characterized by a generally cylindrical tool 10 having a shank 8, a shoulder 12 and a pin 14 extending outward from the shoulder. The pin 14 is rotated against a workpiece 16 until sufficent heat is generated, at which point the pin of the tool is plunged into the plasticized workpiece material. Typically, the pin 14 is plunged into the workpiece 16 until reaching the shoulder 12 which prevents further penetration into the workpiece. The workpiece 16 is often two sheets or plates of material that are butted together at a joint line 18. In this example, the pin 14 is plunged into the workpiece 16 at the joint line 18.

Referring to FIG. 1, the frictional heat caused by rotational motion of the pin 14 against the workpiece material 16 causes the workpiece material to soften without reaching a melting point. The tool 10 is moved transversely along the joint line 18, thereby creating a weld as the plasticized material flows around the pin from a leading edge to a trailing edge along a tool path 20. The result is a solid phase and at the joint line 18 along the to path 20 that may be generally indistinguishable from the workpiece material 16, in contrast to the welds produced when using conventional noon-FSW welding technologies.

It is observed that when the shoulder 12 contacts the surface of the workpieces, its rotation creates additional frictional heat that plasticizes a larger cylindrical column of material around the inserted pin 14. The shoulder 12 provides a forging force that contains the upward metal flow caused by the tool pin 14.

During friction stir welding, the area to be welded and the tool are moved relative to each other such that the tool traverses a desired length of the weld joint at a tool/workpiece interface. The rotating friction stir welding tool 10 provides a continual hot working action, plasticizing metal within a narrow zone as it moves transversely along the base metal, while transporting metal from the leading edge of the pin 14 to its trailing edge. As the weld zone cools, there is typically no solidification as no liquid is created as the tool 10 passes. It is often the case, but not always, that the resulting weld is a defect-free, re-crystallized, fine grain microstructure formed in the area of the weld.

Travel speeds are typically 10 to 500 mm/min with rotation rates of 200 to 2000 rpm. Temperatures reached are usually close to, but below, solidus temperatures. Friction stir welding parameters are a function of a material's thermal properties, high temperature flow stress and penetration depth.

Previous patents have taught the benefits of being able to perform friction stir welding with materials that were previously considered to be functionally unweldable. Some of these materials are non-fusion weldable, or just difficult to weld at all. These materials include, for example, metal matrix composites, ferrous alloys such as steel and stainless steel, and non-ferrous materials. Another class of materials that were also able to take advantage of friction stir welding is the superalloys. Superalloys can be materials having a higher melting temperature bronze or aluminum, and may have other elements mixed in as well. Some examples of superalloys are nickel, iron-nickel, and cobalt-based alloys generally used at temperatures above 1000 degrees F. Additional elements commonly found in superalloys include, but are not limited to, chromium, molybdenum, tungsten, aluminum, titanium, niobium, tantalum, and rhenium.

It is noted that titanium is also a desirable material to use for friction stir welding. Titanium is a non-ferrous material, but has a higher melting point than other nonferrous materials. The previous patents teach that a tool for friction stir welding of high temperature materials is made of a material or materials the have a higher melting temperature than the material being friction stir welded. In some embodiments, a superabrasive was used in the tool, sometimes as a coating.

The most common methods for joining metals together either use mechanical fasteners or traditional welding methods. Typical welding methods include resistance welding, TIG welding, MIG welding, laser welding, electron beam welding and variations of these processes. In the automotive industry, one of the most common methods for welding is using resistance spot welding. These welds are typically used to join the frame components of a car or truck together. This is a significant and critical method used to manufacture cars. For example, a typical 4 door sedan will require over 4000 spot welds to create the frame and sub-components of the car.

While the automotive industry is the most visible industry that uses resistance spot welding, there are many industries that utilize this joining method. For the sake of brevity, the automotive industry will be used to illustrate existing problems as well as the novelty of the inventions described within this document.

Resistance spot welding is one of the most common methods used today in industry to join metal components, such as structural sheet metal together. It is the method of choice for joining steel components together. FSSJ is one of the more recent methods used to join aluminum structural components together. It should be noted that a very small percentage of the automotive industry uses structural aluminum components because of high material and joining costs. Therefore, aluminum is generally used only in expensive sports cars marketed to enthusiasts seeking a high power to weight ratio in the car.

In the state of the art, FSSJ is a process that uses a FSW tool 30 made of hardened tool steel such as the one shown in FIG. 2.

As shown in FIG. 3A, the tool 30 is rotated above a lap joint 32 (overlapping aluminum workpieces) of a top sheet 34 and a bottom sheet 36. In FIG. 3B, the tool 30 plunges through the top sheet 34 and part way into the bottom sheet 36 until the shoulder 38 of the tool makes contact with the top sheet. The materials being joined soften but do not melt, but instead flow around the pin 40 of the tool 30 to form a spot joint 42. FIG. 4 is a close-up view of the finished FSSJ spot joint 42 in aluminum.

An important aspect of the prior art is that in order for the material being joined to flow around the tool 30 during FSSJ, surface features are used. FIG. 5 shows some example of surface features which includes, but should not be considered limited to threads on the pin 40 and/or shoulder 38, flats, and other features extending towards or extruding from the tool face profile.

Experience has proven that there are two critical aspects in the FSSJ process used for joining aluminum workpieces. The first aspect is that the tool 30 is used at speeds lower than 4000 RPM. FSW literature is replete with tool RPM data showing that the tool is generally held around 400 to 600 RPM.

The second aspect is that the tool 30 must have surface features to move material around the tool because these features have significant effects on material flow, material properties and any defects that may arise during FSW.

Problems accompanying existing spot welding technology can be divided into two categories; problems with resistance spot welding of steel and problems with FSSJ of aluminum. For resistance spot welding of aluminum, it is not attempted since the aluminum does not bond weld to itself during the liquid and solidification steps of the process, and it has no appreciable strength. As for FSSJ of steel, it has not been successful because of tool material limitations and bulky expensive equipment costs.

### Problems with Resistance Spot Welding of Steel

The automotive industry in particular is under strict government requirements to improve fuel efficiency of all vehicles in the United States, while other countries are implementing similar standards. One of the easiest ways to achieve this fuel efficiency goal is by reducing the weight of the vehicle. This has led steel producers to develop Advanced High Strength Steels (AHSS) so that lighter weight but stronger steel components can be used to construct the vehicle body while meeting federal safety crash requirements for each vehicle type. Unfortunately, these new AHSS are either extremely difficult to weld or not weldable at all.

Resistance spot welding requires a relatively high degree of material consistency to maintain uniform spot Mint strength. The AHSS do not have this consistency because they are mechanically worked to produce the high strength values. Once the AHSS is melted during a welding process, these properties are severely degraded. Generally speaking, the higher the strength of steel the more difficult to weld, if it can be welded at all. This problem arises from the high alloy content required to achieve the high strength. High alloy content equates to greater hardenability, and greater levels of hardenability create brittle microstructures which can have poor impact strength, susceptibility to cracking, and reduced fatigue life.

FSSJ of steels has also met with little success. Tool materials such as Polycrystalline Cubic Boron Nitride (PCBN) have had limited success joining the AHSS. Since the materials being joined have such high strength, the forces required to penetrate these materials with a PCBN tool are extremely high. This increases the head weight of a FSSJ device that would attach to the arm of a robot. It also decreases the throat size or reach of the head because of the deflection caused at such high loads.

Simply put, the existing geometries of resistance spot welding heads cannot be used and more stout compact head designs would have very limited access to the applications. Along with the high spindle loads comes an increase in torque requirements needed to move the AHSS steel around the tool as the material softens. That means there are high axial tool forces along with high torsional forces about the tool axis that the equipment must accommodate in structure and motor horsepower. PCBN is an expensive diamond-like material that is now pushed to its ultimate material strength limits as a result of the high forces and cyclic temperatures during each FSSJ cycle. This results in early tool failure and eliminates any economic advantage.

Accordingly, the automotive industry is quickly coming to an impasse between not being able to resistance spot weld AHSS and not having a cost effective and capable FSSJ process to manufacture vehicles required to meet mandated fuel efficiency standards.

### Problems with FSSJ of Aluminum

Even with the small number of successful FSSJ applications in aluminum there are technical barriers that prevent the technology from being implemented further. Once the application has determined that aluminum is the best material to use, the high thermal conductivity of aluminum creates problems for the FSSJ process. As the FSSJ tool plunges into the aluminum, it is very difficult to build up heat to soften the material around the tool. This creates high loads that must be reacted by the equipment. Typically, a C frame FSSJ head is used to rotate the to and apply the loads and react the forces generated by the process. The high loads require equipment that will not deflect so the tool position can be maintained during the process. In addition, the horsepower requirements of the spindle motor are high in order to overcome the torsional loads experienced by the process.

Accordingly, what is needed is a way to join AHSS that can be used in the automotive and other industries.

### BRIEF SUMMARY OF THE INVENTION

It is an object of the present invention to provide a system and method for using Friction Stir Spot Joining (FSSJ) to loin workplaces made of Advanced High Strength Steels (AHSS), wherein a first embodiment is a FSSJ tool that has no surface features, and wherein the rate of rotation of the FSSJ tool is much higher than is used in other FSW techniques to thereby reduce torque by causing plasticization of the AHSS on a small scale, and in a second embodiment, conventional FSSJ tools can be used at conventional FSSJ speeds if the FSSJ tool is manufactured from conductive tool materials having a high hardness, and heating of the FSSJ tool and/or the workpieces enhances the ability of the FSSJ tool to functionally weld the AHSS.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is an illustration of the prior at showing friction stir welding of planar workpieces.

FIG. 2 is a FSSJ spot welding tool made from hardened tool steel as found in the prior art.

FIG. 3A is a perspective view of the FSSJ spot welding tool of FIG. 2 hovering over the two aluminum workpieces at a lap joint.

FIG. 3B is a perspective view of the FSSJ spot welding tool of FIG. 2 that has been plunged into the two aluminum workpieces at a lap joint.

FIG. 4 is a close-up perspective view of the friction stir spot Mint.

FIG. 5 is a perspective view of a FSSJ tool having surface features found in the prior art.

FIG. 6 is a perspective view of a FSSJ tool as taught in a first embodiment of the present invention, wherein the FSSJ tool has no surface features.

FIG. 7 is a close-up perspective view of a second embodiment of a pin and shoulder profile that can be used to perform FSSJ of AHSS.

FIG. 8 is a third embodiment showing a perspective view of an induction coil for hybrid heat generation.

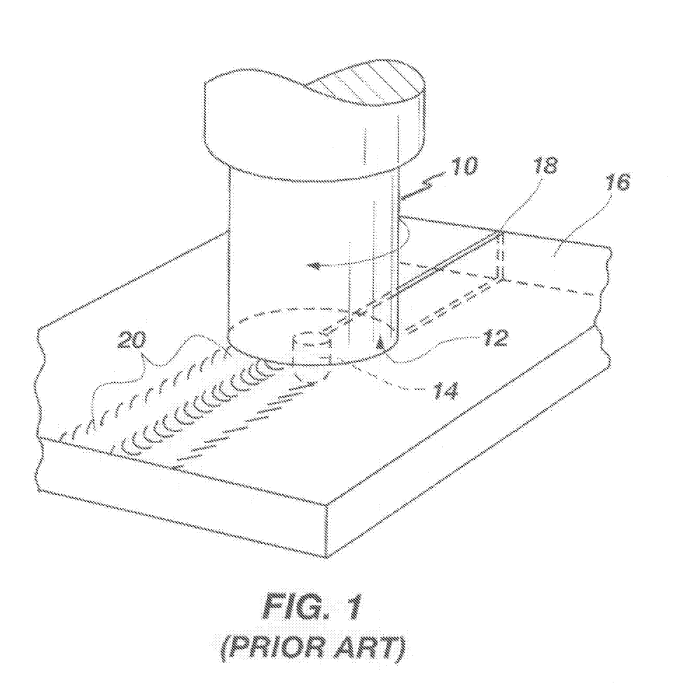

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The present invention uses two different approaches to solve the problem of how to join AHSS workpieces. However, while a main motive for creation of the present invention is to enable FSSJ of AHSS used in vehicles in order to weld strong but lightweight materials in the construction of vehicles that will result in improved gas mileage, the principles of the present invention are applicable to many different materials, and not just AHSS.

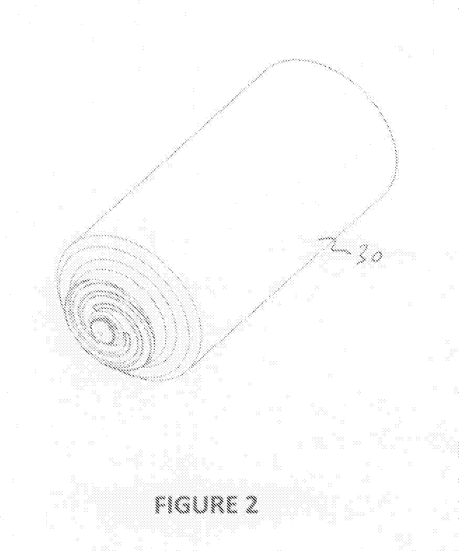

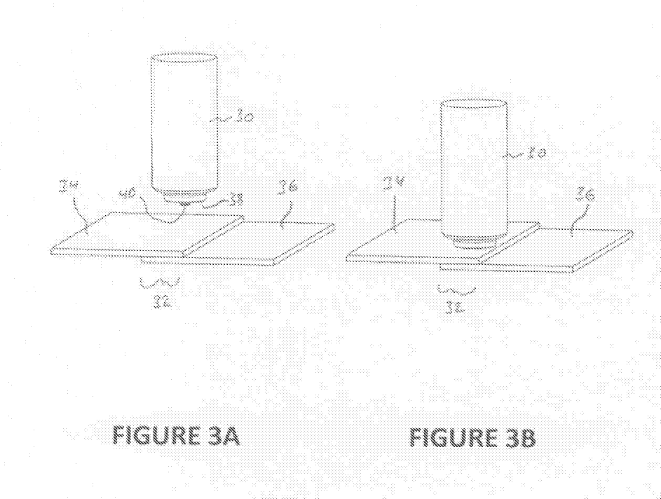

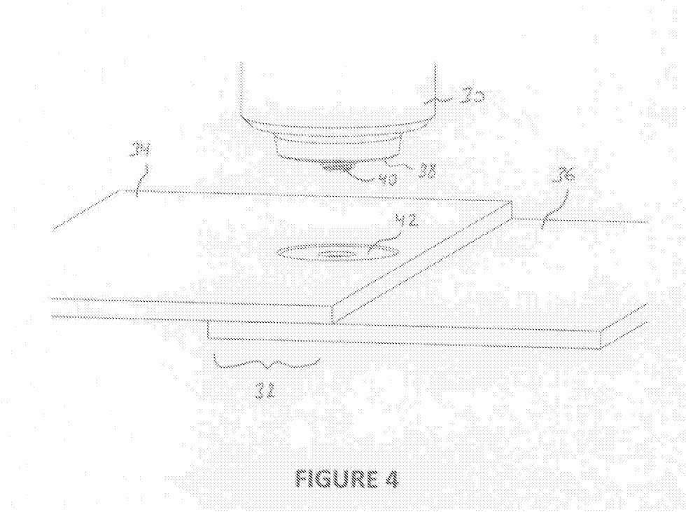

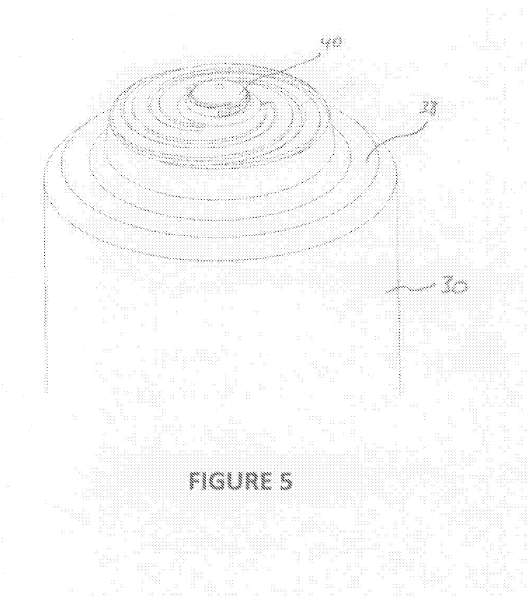

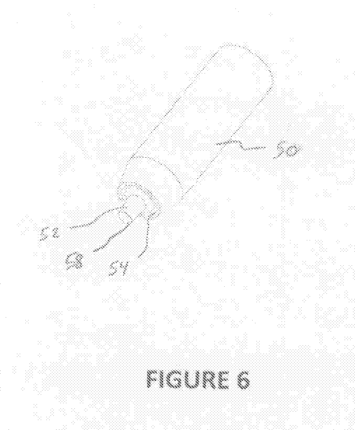

The first approach is a combination of tool features and operation of the FSSJ tool. FIG. 6 is a perspective view of a FSSJ tool that can be used in this first embodiment of the present invention. In contrast to tools used in the prior art, as exemplified in FIGS. 2 through 5, the present invention removes all surface features. As shown in FIG. 6, the FSSJ tool 50 has a pin 52, a shoulder 54, and no surface features. The surface features that are eliminated are threads on the pin 52 and/or shoulder 54, flats, and other features extending towards or extruding from the tool face profile.

Once the surface features are removed from the pin 52 and the shoulder 54, or lust the shoulder if no pin is present, the FSSJ tool 50 is rotated at high rates of speed relative to other FSSJ tools. To operate as desired, it has been determined that the FSSJ tool 50 needs to rotate at speeds above 4000 RPM. This is a dramatic shift from the FSW paradigm wherein “bulk” layer of material is moved around the tool during FSW by the surface features.

At least two significant results occur when using a FSSJ tool 50 with no surface features and when rotating above 4000 RPMs. First, at higher RPMs, there is less torque on the FSSJ tool 50. Second, the interface of the FSSJ tool and a workpiece (“tool/workpiece interface”) experiences rapid heating. When the FSSJ tool 50 is plunged into a workpiece, the workpiece is heated at this tool/workpiece interface and heat is transferred away from the tool/workpiece interface to heat bulk material around the tool profile.

What is significant is that in effect, the high RPMs of the FSSJ tool 50 create softening on a microscopic scale rather than on a macroscopic scale which is typical of FSW. The result is that workpieces such as sheet metal used in automobile construction can be joined using a FSSJ tool in a tool assembly that can operate in the robotic arms of existing assembly robots.

Another result of the first embodiment of the present invention is that there can be a radical departure from prior art FSW design paradigms used to develop and build FSSJ equipment. The equipment must be able to handle FSSJ tool RPMs as high as 50,000 RPMs. Furthermore, special precision balanced tool holding systems may be useful to hold the FSSJ tool precisely, spindle bearings must be designed for speeds above 4000 RPMs, and special spindle motors might also be needed.

In an alternative embodiment of the present invention, variations of this first embodiment include using dissimilar tool materials to construct the FSSJ tool 50 in order to have different frictional couples at different locations on the FSSJ tool. In other words, by using different materials or different areas of the FSSJ tool 50, it is possible to cause some parts of the FSSJ tool to cause more heating with materials that the FSSJ tool comes into contact with than other parts of the FSSJ tool.

While the present invention makes possible the FSSJ of AHSS, other materials can also be welded using the present invention. These materials include all those that are presently being used in the construction of vehicles, and should be considered to be within the scope of the claims.

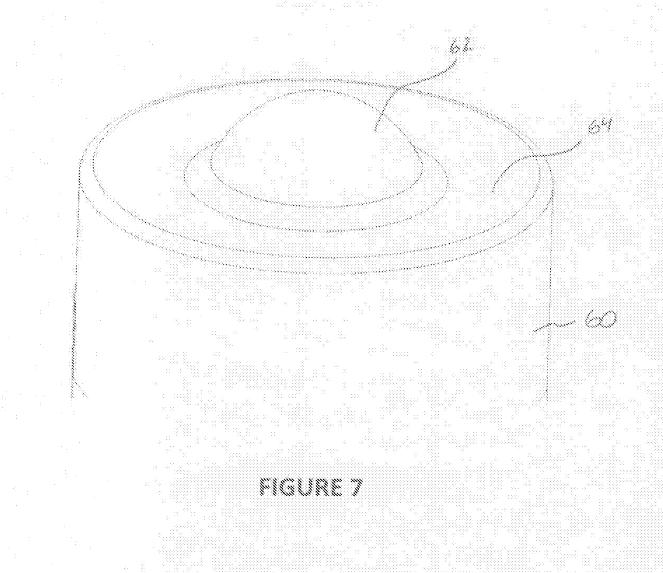

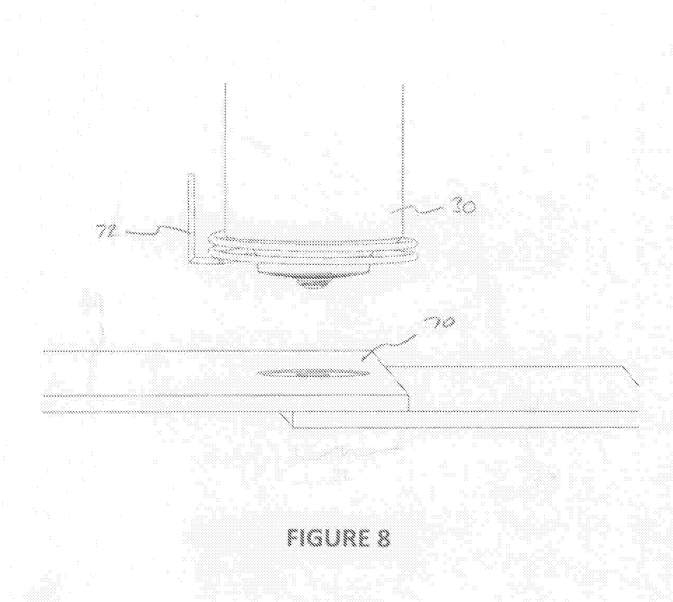

In a second embodiment of the present invention, another FSSJ tool 60 is provided which is related to the FSSJ tool 50 in FIG. 6. In FIG. 7, the FSSJ tool 60 can also be classified as “featureless”. However, unlike the FSSJ tool 50 of FIG. 6 which includes a shoulder 64 and a pin 52 having a frusto-conical shape with an edge 58, the pin 62 of the second embodiment is a dome which does not have any edges.

It is noted that the edge 58 of the FSSJ tool 50 of the first embodiment does not impede rotation of the FSSJ tool because it has no features that would inhibit the path of rotation of the FSSJ tool.

Accordingly, an aspect of the present invention is that any FSSJ tool 50 can be considered to be within the scope of the claims of the present invention which does not include surface features that can grab the workpiece material or cause increased flow around the tool. An important aspect, therefore, is to eliminate those features that might cause the FSSJ tool 50 to agitate the workplace material beyond what will occur when a featureless FSSJ tool will cause by rotating at a high rate of speed and plunging into the workpiece. In other words, by eliminating surface features, the FSSJ tool 50 can rotate as rapidly as possible with the least amount of torque on the FSSJ tool.

In the first embodiment of the present invention, a “featureless” design is essentially a smooth pin and shoulder. However, in an alternative embodiment, it may be possible to include some features that do not prevent the FSSJ tool from rotating at speeds greater than 4000 RPMs. In other words, some features may be included which have a minimal impact on the rotational speed or the torque on the FSSJ tool.

Accordingly, in one embodiment, no surface feature on the FSSJ tool would be greater than approximately 10% of the FSSJ tool diameter and still be within the scope of the present invention.

In other aspects of the present invention, insulation is disposed between the FSSJ tool and the tool holder that is gripping and rotating the FSSJ tool. THE FSSJ tool can employ liquid cooling or gaseous flow to keep the FSSJ tool cool. The shoulder of the FSSJ tool is convex. An inert shielding gas can be used around the FSSJ tool to improve the workpiece flow during the FSSJ process. In addition, the tip of the pin should have a radius that is always greater than 1.1% of the FSSJ tool radius.

In a second embodiment of the present invention, instead of increasing a rate of rotation of the FSSJ tool 30 and removing surface features, a conventional state of the art FSSJ tool is used, including any of the conventional surface features used to cause flow of the workpiece 70. The key to using a conventional FSSJ tool 30 is to add heat to the workpiece 70 and thereby increase the ability of the workpiece to flow under conventional rotation rates and with conventional surface features. One method of applying heat is through a coil 72.

Specifically, a modified FSSJ tool 30 that enables the application of heat to the tool, to the workpiece 70 or to the tool and the workpiece can be used that will also enable the use of a FSSJ tool to be used to functionally weld steels and aluminum, while rotating at typical FSW speeds. In this second embodiment, the purpose of the heating is to improve the flow of the workpiece 70 material during the FSSJ process. Applying heat can be useful during different stages of the FSSJ process. Some of the factors that affect when and where the heat should be applied include the specific workpiece 70 materials being spot welded, the configuration of the FSSJ tool 30, the user of a shieldinq gas, and the surface features that are on the FSSJ tool.

The times and locations that heat can be applied include to the workpiece prior to FSSJ, during FSSJ and/or after FSSJ. Likewise, heat can be applied to the FSSJ tool itself in order to heat the workpiece through contact with the tool before, during and/or after FSSJ.

Any means that can be employed to heat the FSSJ tool and/or the workpiece can be used and should be considered to be within the scope of the claims of the present invention. The heating methods include but should not be considered to be limited to induction heating and resistive heating.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for performing friction stir spot joining (FSSJ) of metal workpieces, said method comprising the steps of:
1) providing a FSSJ tool comprised of a shank, a shoulder and a pin, wherein the shoulder and the pin have smooth surfaces and no features extending towards or extruding from a FSSJ tool profile;
2) rotating the FSSJ tool at a rate of speed that is greater than 4000 revolutions per minute (RPM); and
3) plunging the FSSJ tool into and then removing the FSSJ tool from at least two metal workpieces, resulting in a spot weld of the at least two metal workpieces.

2. The method as defined in claim 1 wherein the method further comprises the step of selecting the at least two metal workpieces from the group of materials comprised of Advanced High Strength Steels (AHSS), steel and aluminum.

3. The method as defined in claim 1 wherein the method further comprises the step of providing a pin having a frusto-conical shape.

4. The method as defined in claim 1 wherein the method further comprises the step of providing a pin having a dome shape.

5. The method as defined in claim 1 wherein the method further comprises the step of reducing torque on the FSSJ tool by removing surface features from the FSSJ tool.

6. The method as defined in claim 1 wherein the method further comprises the step of rapidly heating a tool/workpiece interface, wherein the tool/workpiece interface is located where the FSSJ tool makes contact with any part of the at least two workpieces.

7. The method as defined in claim 1 wherein the method further comprises the step of reducing a macroscopic friction stirring effect on the at least two workpieces.

8. The method as defined in claim 1 wherein the method further comprises the step of using dissimilar tool materials in the FSSJ tool to thereby obtain different frictional couples at different locations of the FSSJ tool.

9. A method for performing friction stir spot joining (FSSJ) of metal workplaces, said method comprising the steps of:
1) providing a FSSJ tool comprised of a shank, a shoulder and a pin, wherein the shoulder and the pin have features extending towards or extruding from a FSSJ tool profile;
2) rotating the FSSJ tool at a rate of speed that is greater than 4000 revolutions per minute (RPM); and
3) plunging the FSSJ tool into and then removing the FSSJ tool from at least two metal workpieces, resulting in a spot weld of the at least two metal workpieces.

10. The method as defined in claim 9 wherein the method further comprises the step of making the features less than 10% of the FSSJ tool diameter.

11. A method for performing friction stir spot joining (FSSJ) of metal workpieces, said method comprising the steps of:
1) providing a FSSJ tool comprised of a shank, a shoulder and a pin, wherein the shoulder and the pin have features extending towards or extruding from a FSSJ tool profile;
2) providing a means for heating the FSSJ tool to thereby more rapidly heat at least a portion of at least two metal workpieces that come into contact with the FSSJ tool, thereby increasing a rate of flow of the at least two metal workpieces around the FSSJ tool; and
4) plunging the FSSJ tool into and then removing the FSSJ tool from the at least two metal workpieces, resulting in a spot weld of the at least two metal workpieces.

12. The method as defined in claim 11 wherein the method further comprises the step of heating the at least two metal workplaces to thereby increase a rate of flow of the at least two metal workplaces around the FSSJ tool.

13. The method as defined in claim 12 wherein the method further comprises the step of selectively heating the FSSJ tool and the at least two workpieces before, during or after the FSSJ tool creates a spot weld in the at least two workpieces.

14. The method as defined in claim 12 wherein the method further comprises the step of selecting the means of heating the FSSJ tool and the at least two workpieces from the group of heating means comprised of inductive heating and resistive heating.

15. A system for performing friction stir spot joining (FSSJ) of metal workpieces, said system comprised of:
a FSSJ tool comprised of a shank, a shoulder and a pin, wherein the shoulder and the pin have smooth surfaces and no features extending towards or extruding from a FSSJ tool profile; and
a rotation means for rotating the FSSJ tool at a rate of speed that is greater than 4000 revolutions per minute (RPM).

16. The system as defined in claim 15 wherein the at least two metal workpieces are selected from the group of materials comprised of Advanced High Strength Steels (AHSS), steel and aluminum.

17. The system as defined in claim 15 wherein the pin has a frusto-conical shape.

18. The system as defined in claim 15 wherein the pin has a dome shape.

19. The system as defined in claim 15 wherein the FSSJ tool is further comprised of dissimilar tool materials to thereby obtain different frictional couples at different locations of the FSSJ tool.
